(19) United States
(12) Patent Application Publication
(10) Pub. No.: US 2016/0103655 A1
(43) Pub. Date: Apr. 14, 2016

(54) Co-Verbal Interactions With Speech Reference Point

(71) Applicant: Microsoft Corporation, Redmond, WA (US)

(72) Inventor: Christian Klein, Duvall, WA (US)

(21) Appl. No.: 14/509,145

(22) Filed: Oct. 8, 2014

(51) Int. Cl. G06F 3/16; G10L 15/22

(52) U.S. Cl. CPC G06F 3/167; G10L 15/22; G10L 2015/223

(57) ABSTRACT

Example apparatus and methods improve efficiency and accuracy of human device interactions by combining speech with other input modalities (e.g., touch, hover, gestures, gaze) to create multi-modal interactions that are more natural and more engaging. Multi-modal interactions expand a user's expressive power with devices. A speech reference point is established based on a combination of prioritized or ordered inputs. Co-verbal interactions occur in the context of the speech reference point. Example co-verbal interactions include a command, a dictation, or a conversational interaction. The speech reference point may vary in complexity from a single discrete reference point (e.g., single touch point) to multiple simultaneous reference points to sequential reference points (single touch or multi-touch), to analog reference points associated with, for example, a gesture. Establishing the speech reference point allows surfacing additional context-appropriate user interface elements that further improve human device interactions in a natural and engaging experience.

### BACKGROUND

Computing devices continue to proliferate at astounding rates. As of September 2014 there are approximately two billion smart phones and tablets that have touch sensitive screens. Most of these devices have built-in microphones and cameras. Users interact with these devices in many varied and interesting ways. For example, three dimensional (3D) touch or hover sensors are able to detect the presence, position, and angle of user's fingers or implements (e.g., pen, stylus) when they are near or touching the screen of the device. Information about the user's fingers may facilitate identifying an object or location on the screen that a user is referencing. Despite the richness of interaction with the devices using the touch screens, communicating with a device may still be an unnatural or difficult endeavor.

In the human-to-human world, effective communications with other humans involves multiple simultaneous modalities including, for example, speech, eye contact, gesturing, body language, tone, or inflection, all of which may depend on context for their meaning. While humans interact with other humans using multiple modalities simultaneously, humans tend to interact with their devices using a single modality at a time. Using just a single modality may limit the user's expressive power. For example, some interactions (e.g., navigation shortcuts) with devices are accomplished using speech only, while other interactions (e.g., scrolling) are accomplished using gestures only. When using speech commands on a conventional device, the limited context may require a user to speak known verbose commands or to engage in cumbersome back-and-forth dialogs, both of which may be unnatural or limiting. Single modality inputs that have binary results may inhibit learning how to interact with an interface because a user may be afraid of inadvertently doing something that is irreversible.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods improve over conventional approaches to human-to-device interaction by combining speech with other input modalities (e.g., touch, hover, gesture, gaze) to create multi-modal interactions that are more efficient, more natural, and more engaging. These multi-modal inputs that combine speech plus another modality may be referred to as “co-verbal” interactions. Multi-modal interactions expand a user's expressive power with devices. To support multi-modal interactions, a user may establish a speech reference point using a combination of prioritized or ordered inputs. Feedback about the establishment or location of the speech reference point may be provided to further improve interactions. Co-verbal interactions may then occur in the context of the speech reference point. For example, a user may speak and gesture at the same time to indicate where the spoken word is directed. More generally, a user may interact with a device more like they are talking to a person by being able to identify what they're talking about using multiple types of inputs contemporaneously or sequentially with speech.

Example apparatus and methods may facilitate co-verbal interactions that combine speech with other input modalities to accelerate tasks and increase a user's expressive power over any single modality. The co-verbal interaction is directed to an object(s) associated with the speech reference point. The co-verbal interaction may be, for example, a command, a dictation, a conversational interaction, or other interaction. The speech reference point may vary in complexity from a single discrete reference point (e.g., single touch point) to multiple simultaneous reference points to sequential reference points (single touch or multi-touch), all the way to analog reference points associated with, for example, a gesture. Contextual user interface elements may be surfaced when a speech reference point is established.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example device handling a co-verbal interaction with a speech reference point.

FIG. 2 illustrates an example device handling a co-verbal interaction with a speech reference point.

FIG. 3 illustrates an example device handling a co-verbal interaction with a speech reference point.

FIG. 4 illustrates an example device handling a co-verbal interaction with a speech reference point.

FIG. 5 illustrates an example method associated with handling a co-verbal interaction with a speech reference point.

FIG. 6 illustrates an example method associated with handling a co-verbal interaction with a speech reference point.

FIG. 7 illustrates an example cloud operating environment in which a co-verbal interaction with a speech reference point may be made.

FIG. 8 is a system diagram depicting an exemplary mobile communication device that may support handling a co-verbal interaction with a speech reference point.

FIG. 9 illustrates an example apparatus for handling a co-verbal interaction with a speech reference point.

FIG. 10 illustrates an example apparatus for handling a co-verbal interaction with a speech reference point.

FIG. 11 illustrates an example device having touch and hover sensitivity.

FIG. 12 illustrates an example user interface that may be improved using a co-verbal interaction with a speech reference point.

### DETAILED DESCRIPTION

Example apparatus and methods improve over conventional approaches to human-to-device interaction by combining speech with other input modalities (e.g., touch, hover, gesture, gaze) to create multi-modal (e.g., co-verbal) interactions that are more efficient, more natural, and more engaging. To support multi-modal interactions, a user may establish a speech reference point using a combination of prioritized or ordered inputs from a variety of input devices. Co-verbal interactions that include both speech and other inputs (e.g., touch, hover, gesture, gaze) may then occur in the context of the speech reference point. For example, a user may speak and gesture at the same time to indicate where the spoken word is directed. Being able to speak and gesture may facilitate, for example, moving from field to field in a text or email application without having to touch the screen to move from field to field. Being able to speak and gesture may also facilitate, for example, applying a command to an object without having to touch the object or touch a menu. For example, a speech reference point may be established and associated with a photograph displayed on a device. The co-verbal command may then cause the photograph to be sent to a user based on a voice command. Being able to speak and gesture may also facilitate, for example, engaging in a conversation or dialog with a device. For example, a user may be able to refer to a region (e.g., within one mile of “here”) by pointing to a spot on a map and then issue a request (e.g., find Italian restaurants within one mile of “here”. In both the photograph and map example it may have been difficult in conventional systems to describe the object or location.

Example apparatus and methods may facilitate co-verbal interactions that combine speech with other input modalities to accelerate tasks and increase a user's expressive power over any single modality. The co-verbal interaction may be directed to an object(s) associated with the speech reference point. The speech reference point may vary from a simple single discrete reference point (e.g., single touch point) to multiple simultaneous reference points to sequential reference points (single touch or multi-touch), all the way to analog reference points associated with, for example, a gesture. For example, a user may identify a region around a busy sports stadium using a gesture over a map and then ask for directions from point A to point B that avoid the busy sports stadium.

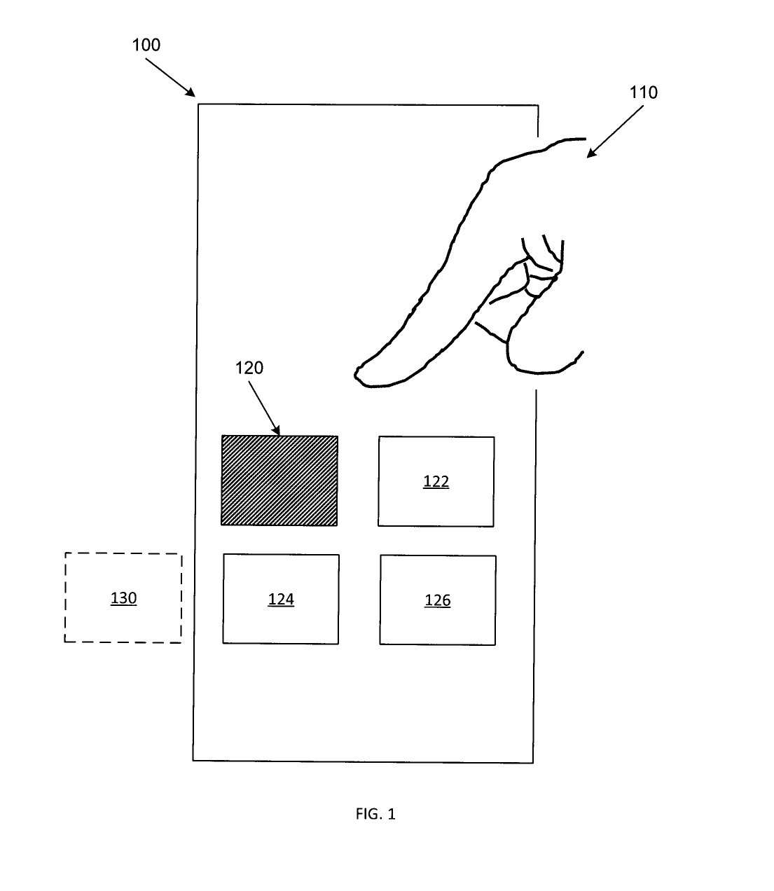

FIG. 1 illustrates an example device 100 handling a co-verbal interaction with a speech reference point. A user may use their finger 110 to point to a portion of a display on device 100. FIG. 1 illustrates an object 120 that has been pointed to and with which a speech reference point has been associated. When the user speaks a command, the command will be applied to the object 120. Object 120 exhibits feedback (e.g., highlighting, shading) that indicates that the speech reference point is associated with object 120. Objects 122, 124, and 126 do not exhibit the feedback and thus a user would know that object 120 is associated with the speech reference point and objects 122, 124, and 126 are not associated with the speech reference point. An object 130 is illustrated off the screen of device 100. In one embodiment, the speech reference point may be associated with an object located off the device 100. For example, if device 100 was sitting on a desk beside a second device, then the user might use their finger 110 to point to an object on the second device and thus might establish the speech reference point as being associated with the other device. Even more generally, a user might be able to indicate another device to which a co-verbal command would then be applied by device 100. For example, device 100 may be a smart phone and the user of device 100 may be watching a smart television. The user may use the device 100 to establish a speech reference point associated with the smart television and then issue a co-verbal command like “continue watching this show on that screen,” where “this” and “that” are determined as a function of the co-verbal interaction. The command may be processed by device 100 and then device 100 may control the second device.

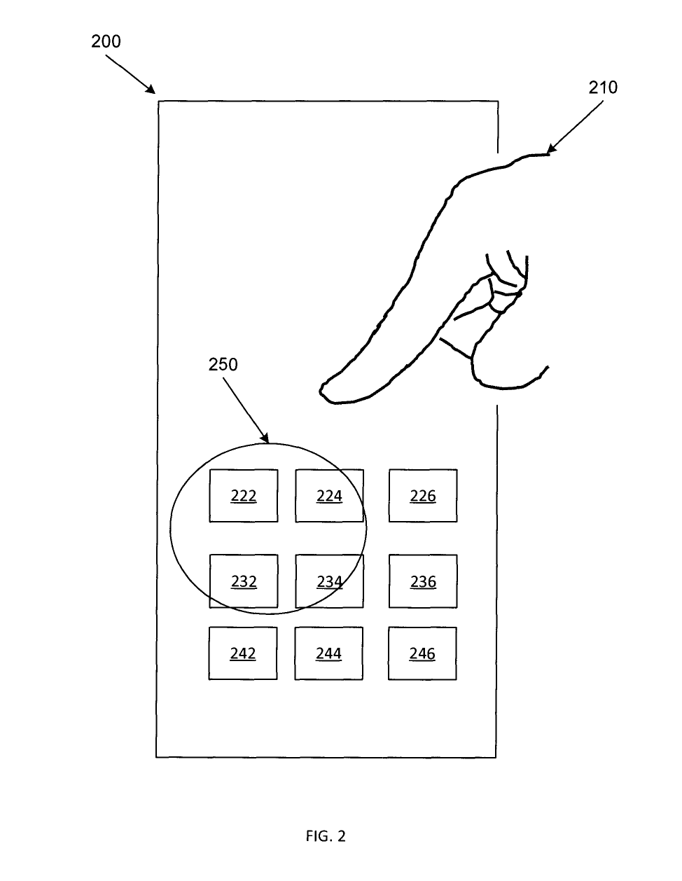

FIG. 2 illustrates an example device 200 handling a co-verbal interaction with a speech reference point. A user may use their finger 210 to draw or otherwise identify a region 250 on a display on device 200. The region 250 may cover a first set of objects (e.g., 222, 224, 232, 234) and may not cover a second set of objects (e.g., 226, 236, 242, 244, 246). Once a user has established a region, the user may then perform a co-verbal command that affects the covered objects but does not affect the objects that are not covered. For example, a user might say “delete those objects” to delete objects 222, 224, 232, and 234. In another embodiment, the region 250 might be associated with, for example, a map. In this example, the objects 222 . . . 246 may represent buildings on the map or city blocks on the map. In this embodiment, the user might say “find Italian restaurants in this region” or “find dry cleaners outside this region.” A user may want to find things inside region 250 because they are nearby. A user may want to find things outside region 250 because, for example, a sporting event or demonstration may be clogging the streets in region 250. While a user finger 210 is illustrated, a region may be generated using implements like a pen or stylus, or using effects like smart ink. “Smart ink”, as used herein, refers to visual indicia of “writing” performed using a finger, pen, stylus, or other writing implement. Smart ink may be used to establish a speech reference point by, for example, circling, underlining, or otherwise indicating an object.

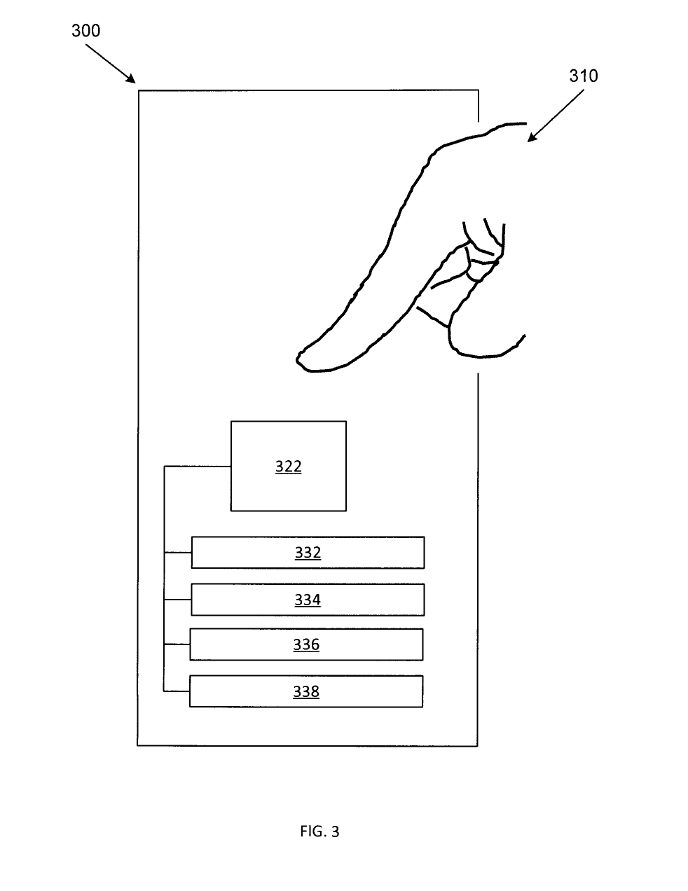

FIG. 3 illustrates an example device 300 handling a co-verbal interaction with a speech reference point. A user may use their finger 310 to point to a portion of a display on device 300. When a speech reference point is established and associated with, for example, object 322, then additional user interface elements may be surfaced (e.g., displayed) on device 300. The additional user interface elements would be relevant to what can be accomplished with object 322. For example, a menu having four entries (e.g., 332, 334, 336, 338) may be displayed and a user may then be able to select a menu item using a voice command. For example, the user could say “choice 3” or read a word displayed on a menu item. Being able to selectively surface relevant user interface elements based on establishment of a speech reference point improves over conventional systems by reducing complexity while saving display real estate. Display real estate may also be preserved when, for example, the displayed menu options are representative examples of a larger set of available commands. The menu may provide content to a user who may then speak commands that may not be displayed in a traditional menu system. Users are presented with relevant user interface elements at relevant times and in context with an object that they have associated with a speech reference point. This may facilitate improved learning where a user may point at an unfamiliar icon and ask “what can I do with that?” The user would then be presented with relevant user interface elements as part of their learning experience. Similarly, a user may be able to “test drive” an action without committing to the action. For example, a user might establish a speech reference point over an icon and ask “what happens if I press that?” The user could then be shown a potential result or a voice agent could provide an answer. While a menu is illustrated, other user interface elements may also be presented.

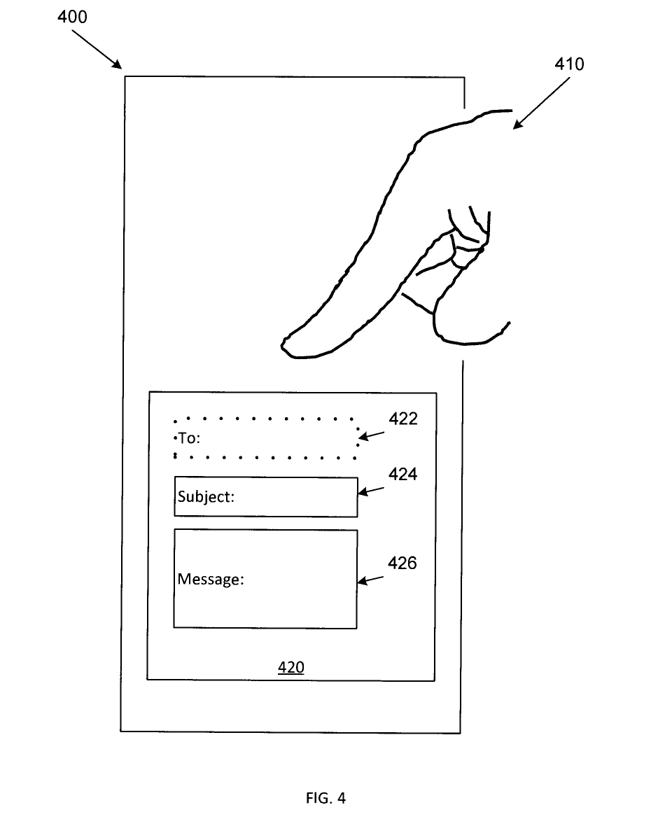

FIG. 4 illustrates an example device 400 handling a co-verbal interaction with a speech reference point. A user may use their finger 410 to point to a portion of a display on device 400. For example, an email application may include a “To” field 422, a “subject” field 424, and a “message” field 426. Conventionally, a user may need to touch each field in order to be able to then type inputs in the fields. Example apparatus and methods are not so limited. For example, a user may establish a speech reference point with the “To” field 422 using a gesture, gaze, touch, hover, or other action. Field 422 may change in appearance to provide feedback about the establishment of the speech reference point. The user may now use a co-verbal command to, for example, dictate an entry to go in field 422. When the user is done dictating the contents of field 422, the user may then use another co-verbal command (e.g., point at next field, speak and point at next field) to navigate to another field. This may provide superior navigation when compared to conventional systems and thus reduce the time required to navigate in an application or form.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

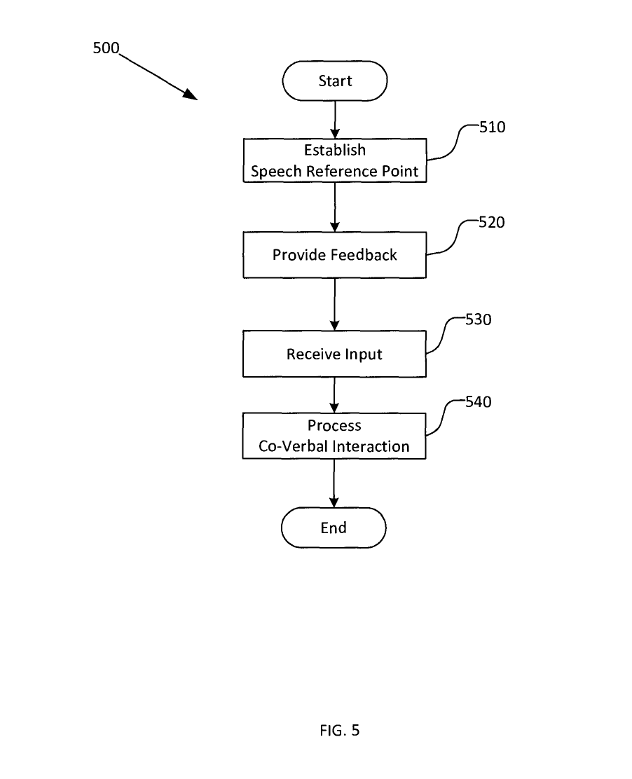

FIG. 5 illustrates an example method 500 for handling co-verbal interactions in association with a speech reference point. Method 500 includes, at 510, establishing a speech reference point for a co-verbal interaction between a user and a device. The device may be, for example, a cellular telephone, a tablet computer, a phablet, a laptop computer, or other device. The device is speech-enabled, which means that the device can accept voice commands through, for example, a microphone. While the device may take various forms, the device will have at least a visual display and one non-speech input apparatus. The non-speech input apparatus may be, for example, a touch sensor, a hover sensor, a depth camera, an accelerometer, a gyroscope, or other input device. The speech reference point may be established from a combination of voice and non-voice inputs.

The location of the speech reference point is determined, at least in part, by an input from the non-speech input apparatus. Since different types of non-speech input apparatus may be available, the input may take different forms. For example, the input may be a touch point or a plurality of touch points produced by a touch sensor. The input may also be, for example, a hover point or a plurality of hover points produced by a proximity sensor or other hover sensor. The input may also be, for example, a gesture location, a gesture direction, a plurality of gesture locations, or a plurality of gesture directions. The gestures may be, for example, pointing at an item on the display, pointing at another object that is detectable by the device, circling or otherwise bounding a region on a display, or other gesture. The gesture may be a touch gesture, a hover gesture, a combined touch and hover gesture or other gesture. The input may also be provided from other physical or virtual apparatus associated with the device. For example, the input may be a keyboard focus point, a mouse focus point, or a touchpad focus point. While fingers, pens, stylus and other implements may be used to generate inputs, other types of inputs may also be accepted. For example, the input may be an eye gaze location or an eye gaze direction. Eye gaze inputs may improve over conventional systems by allowing “hands-free” operation for a device. Hands-free operation may be desired in certain contexts (e.g., while driving) or in certain environments (e.g., physically challenged user).

Establishing the speech reference point at 510 may involve sorting through or otherwise analyzing a collection of inputs. For example, establishing the speech reference point may include computing an importance of a member of a plurality of inputs received from one or more non-speech input apparatus. Different inputs may have different priorities and the importance of an input may be a function of a priority. For example, an explicit touch may have a higher priority than a fleeting glance by the eyes.

Establishing the speech reference point at 510 may also involve analyzing the relative importance of an input based, at least in part, on a time at which or an order in which the input was received with respect to other inputs. For example, a keyboard focus event that happened after a gesture may take precedence over the gesture.

The speech reference point may be associated with different numbers or types of objects. For example, the speech reference point may be associated with a single discrete object displayed on the visual display. Associating the speech reference point with a single discrete object may facilitate co-verbal commands of the form “share this with Joe.” For example, a speech reference point may be associated with a photograph on the display and the user may then speak a command (e.g., “share”, “copy”, “delete”) that is applied to the single item.

In another example, the speech reference point may be associated with two or more discrete objects that are simultaneously displayed on the visual display. For example, a map may display several locations. In this example, a user may select a first point and a second point and then ask “how far is it between the two points?” In another example, a visual programming application may have sources, processors, and sinks displayed. A user may select a source and a sink to connect to a processor and then speak a command (e.g., “connect these elements”).

In another example, the speech reference point may be associated with two or more discrete objects that are referenced sequentially on the visual display. In this example, a user may first select a starting location and then select a destination and then say “get me directions from here to here.” In another example, a visual programming application may have flow steps displayed. A user may trace a path from flow step to flow step and then say “compute answer following this path.”

In another example, the speech reference point may be associated with a region. The region may be associated with one or more representations of objects on the visual display. For example, the region may be associated with a map. The user may identify the region by, for example, tracing a bounding region on the display or making a gesture over a display. Once the bounding region is identified, the user may then speak commands like “find Italian restaurants in this region” or “find a way home but avoid this area.”

Method 500 includes, at 520, controlling the device to provide a feedback concerning the speech reference point. The feedback may identify that a speech reference point has been established. The feedback may also identify where the speech reference point has been established. The feedback may take forms including, for example, visual feedback, tactile feedback, or auditory feedback that identifies an object associated with the speech reference point. The visual feedback may be, for example, highlighting an object, animating an object, enlarging an object, bringing an object to the front of a logical stack of objects, or other action. The tactile feedback may include, for example, vibrating a device. The auditory feedback may include, for example, making a beeping sound associated with selecting an item, making a dinging sound associated with selecting an item, or other verbal cue. Other feedback may be provided.

Method 500 also includes, at 530, receiving an input associated with a co-verbal interaction between the user and the device. The input may come from different input sources. The input may be a spoken word or phrase. In one embodiment, the input combines a spoken sound and another non-verbal input (e.g., touch).

Method 500 also includes, at 540, controlling the device to process the co-verbal interaction as a contextual voice command. A contextual voice command has a context. The context depends, at least in part, on the speech reference point. For example, when the speech reference point is associated with a menu, the context may be a “menu item selection” context. When the speech reference point is associated with a photograph, the context may be a “share, delete, print” selection context. When the speech reference point is associated with a text input field, then the context may be “take dictation.” Other contexts may be associated with other speech reference points.

In one embodiment, the co-verbal interaction is a command to be applied to an object associated with the speech reference point. For example, a user may establish a speech reference point with a photograph. A printer and a garbage bin may also be displayed on the screen on which the photograph is displayed. The user may then make a gesture with a finger towards one of the icons (e.g., printer, garbage bin) and may reinforce the gesture with a spoken word like “print” or “trash.” Using both a gesture and voice command may provide a more accurate and more engaging experience.

In one embodiment, the co-verbal interaction is dictation to be entered into an object associated with the speech reference point. For example, a user may have established a speech reference point in the body of a word processing document. The user may then dictate text that will be added to the document. In one embodiment, the user may also make contemporaneous gestures while speaking to control the format in which the text is entered. For example, a user may be dictating and making a spread gesture at the same time. In this example, the entered text may have its font size increased. Other combinations of text and gestures may be employed. In another example, a user may be dictating and shaking the device at the same time. The shaking may indicate that the entered text is to be encrypted. The rate at which the device is shaken may control the depth of the encryption (e.g., 16 bit, 32 bit, 64 bit, 128 bit). Other combinations of dictation and non-verbal inputs may be employed.

In one example, the co-verbal interaction may be a portion of a conversation between the user and a speech agent on the device. For example, the user may be using a voice agent to find restaurants. At some point in the conversation the voice agent may reach a branch point where a yes/no answer is required. The device may then ask “is this correct?” The user may speak “yes” or “no” or the user may nod their head or blink their eyes or make some other gesture. At another point in the conversation the voice agent may reach a branch point where a multi-way selection is required. The device may then ask the user to “pick one of these choices.” The user may then gesture and speak “this one” to make the selection.

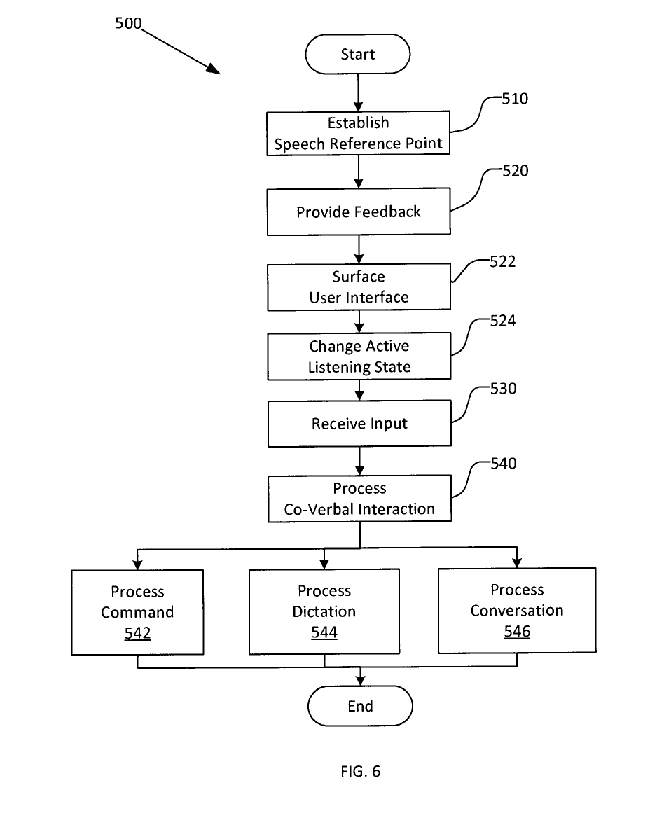

FIG. 6 illustrates another embodiment of method 500. This embodiment includes additional actions. For example, this embodiment also includes, at 522, controlling the device to present an additional user interface element. The user interface element that is presented may be selected based, at least in part, on an object associated with the speech reference point. For example, if a menu is associated with the speech reference point, then menu selections may be presented. If a map is associated with the speech reference point, then a magnifying glass effect may be applied to the map at the speech reference location. Other effects may be applied. For example, a preview of what would happen to a document may be provided when a user establishes a speech reference point with an effect icon and says “preview.”

This embodiment of method 500 also includes, at 524, selectively manipulating an active listening mode for a voice agent running on the device. Selectively manipulating an active listening mode may include, for example, turning on active listening. The active listening mode may be turned on or off based, at least in part, on an object associated with the speech reference point. For example, if a user establishes a speech reference point with a microphone icon or with the body of a texting application then the active listening mode may be turned on, while if a user establishes a speech reference point with a photograph the active listening mode may be turned off. In one embodiment, the device may be controlled to provide visual, tactile, or auditory feedback upon manipulating the active listening mode. For example, a microphone icon may be lit, a microphone icon may be presented, a voice graph icon may be presented, the display may flash in a pattern that indicates “I am listening,” the device may ding or make another “I am listening” sound, or provide other feedback.

While FIGS. 5 and 6 illustrate various actions occurring in serial, it is to be appreciated that various actions illustrated in FIGS. 5 and 6 could occur substantially in parallel. By way of illustration, a first process could establish a speech reference point, and a second process could process co-verbal multi-modal commands. While two processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer, phone, tablet) cause the machine to perform methods described or claimed herein including method 500. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

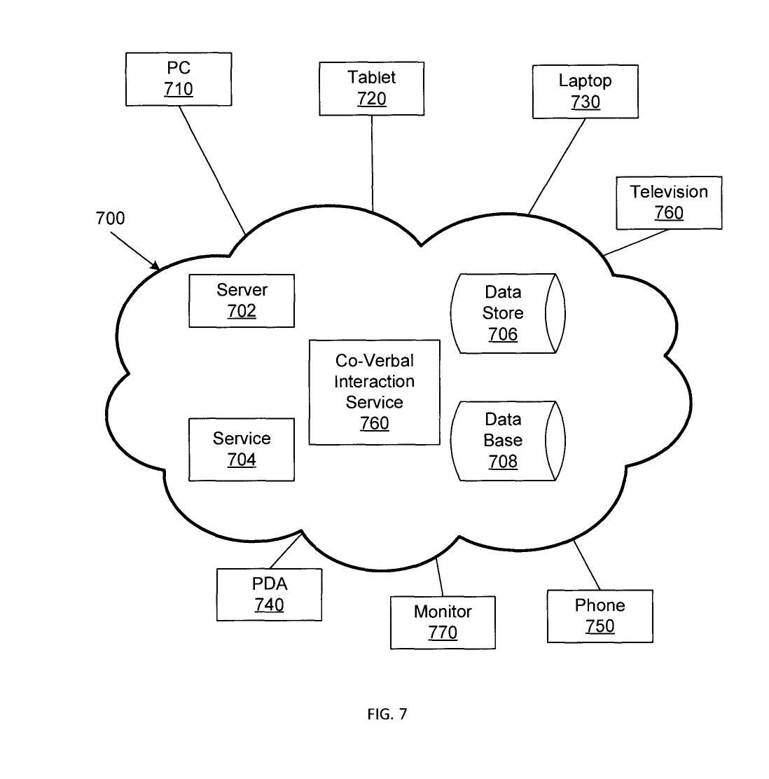

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example co-verbal interaction service 760 residing in the cloud 700. The co-verbal interaction service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the co-verbal interaction service 760.

FIG. 7 illustrates various devices accessing the co-verbal interaction service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. It is possible that different users at different locations using different devices may access the co-verbal interaction service 760 through different networks or interfaces. In one example, the co-verbal interaction service 760 may be accessed by a mobile device 750. In another example, portions of co-verbal interaction service 760 may reside on a mobile device 750. Co-verbal interaction service 760 may perform actions including, for example, establishing a speech reference point and processing a co-verbal command in the context associated with the speech reference point. In one embodiment, co-verbal interaction service 760 may perform portions of methods described herein (e.g., method 500).

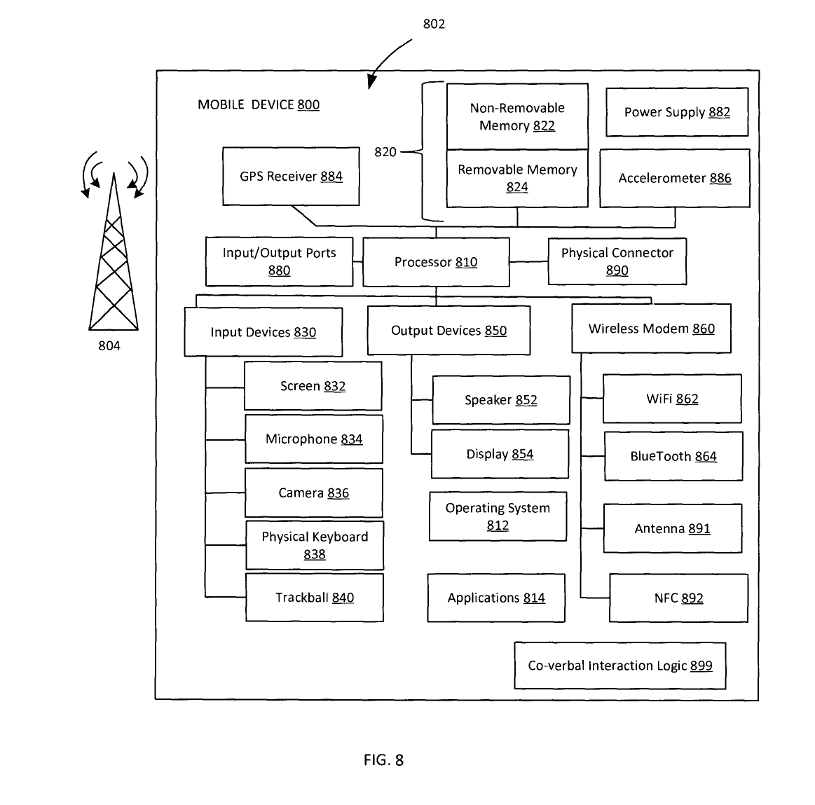

FIG. 8 is a system diagram depicting an exemplary mobile device 800 that includes a variety of optional hardware and software components shown generally at 802. Components 802 in the mobile device 800 can communicate with other components, although not all connections are shown for ease of illustration. The mobile device 800 may be a variety of computing devices (e.g., cell phone, smartphone, tablet, phablet, handheld computer, Personal Digital Assistant (PDA), etc.) and may allow wireless two-way communications with one or more mobile communications networks 804, such as a cellular or satellite networks. Example apparatus may concentrate processing power, memory, and connectivity resources in mobile device 800 with the expectation that mobile device 800 may be able to interact with other devices (e.g., tablet, monitor, keyboard) and provide multi-modal input support for co-verbal commands associated with a speech reference point.

Mobile device 800 can include a controller or processor 810 (e.g., signal processor, microprocessor, application specific integrated circuit (ASIC), or other control and processing logic circuitry) for performing tasks including input event handling, output event generation, signal coding, data processing, input/output processing, power control, or other functions. An operating system 812 can control the allocation and usage of the components 802 and support application programs 814. The application programs 814 can include media sessions, mobile computing applications (e.g., email applications, calendars, contact managers, web browsers, messaging applications), video games, movie players, television players, productivity applications, or other applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include a speech reference point location, an identifier of an object associated with a speech reference point, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a screen 832 that is both touch and hover-sensitive, a microphone 834, a camera 836, a physical keyboard 838, or trackball 840. The mobile device 800 may also support output devices 850 including, but not limited to, a speaker 852 and a display 854. Display 854 may be incorporated into a touch-sensitive and hover-sensitive i/o interface. Other possible input devices (not shown) include accelerometers (e.g., one dimensional, two dimensional, three dimensional), gyroscopes, light meters, and sound meters. Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting touch and hover gestures associated with controlling output actions.

A wireless modem 860 can be coupled to an antenna 891. In some examples, radio frequency (RF) filters are used and the processor 810 need not select an antenna configuration for a selected frequency band. The wireless modem 860 can support one-way or two-way communications between the processor 810 and external devices. The communications may concern media or media session data that is provided as controlled, at least in part, by remote media session logic 899. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a co-verbal interaction logic 899 that provides a functionality for the mobile device 800. For example, co-verbal interaction logic 899 may provide a client for interacting with a service (e.g., service 760, FIG. 7). Portions of the example methods described herein may be performed by co-verbal interaction logic 899. Similarly, co-verbal interaction logic 899 may implement portions of apparatus described herein. In one embodiment, co-verbal interaction logic 899 may establish a speech reference point for mobile device 800 and then process inputs from the input devices 830 in a context determined, at least in part, by the speech reference point.

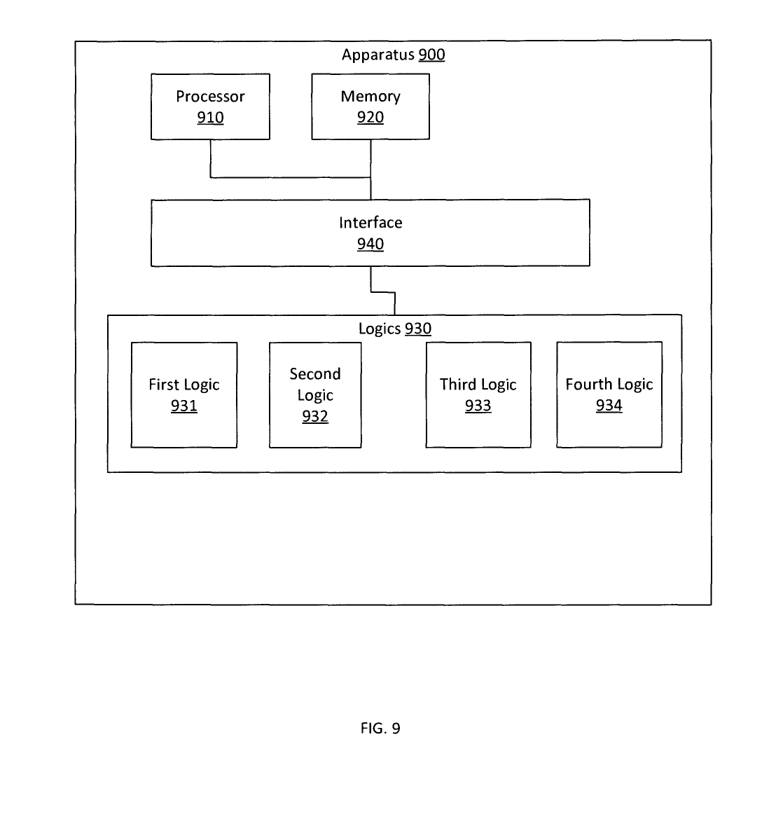

FIG. 9 illustrates an apparatus 900 that may support co-verbal interactions based, at least in part, on a speech reference point. Apparatus 900 may be, for example, a smart phone, a laptop, a tablet, or other computing device. In one example, the apparatus 900 includes a physical interface 940 that connects a processor 910, a memory 920, and a set of logics 930. The set of logics 930 may facilitate multi-modal interactions between a user and the apparatus 900. Elements of the apparatus 900 may be configured to communicate with each other, but not all connections have been shown for clarity of illustration.

Apparatus 900 may include a first logic 931 that handles speech reference point establishing events. In computing, an event is an action or occurrence detected by a program that may be handled by the program. Typically, events are handled synchronously with the program flow. When handled synchronously, the program may have a dedicated place where events are handled. Events may be handled in, for example, an event loop. Typical sources of events include users pressing keys, touching an interface, performing a gesture, or taking another user interface action. Another source of events is a hardware device such as a timer. A program may trigger its own custom set of events. A computer program that changes its behavior in response to events is said to be event-driven.

In one embodiment, the first logic 931 handles touch events, hover events, gesture events, or tactile events associated with a touch screen, a hover screen, a camera, an accelerometer, or a gyroscope. The speech reference point establishing events are used to identify the object, objects, region, or devices with which a speech reference point is to be associated. The speech reference point establishing events may establish a context associated with a speech reference point. In one embodiment, the context may include a location at which the speech reference point is to be positioned. The location may be on a display on apparatus 900. In one embodiment, the location may be on an apparatus other than apparatus 900.

Apparatus 900 may include a second logic 932 that that establishes a speech reference point. Where the speech reference point is located, or the object with which the speech reference point is associated may be based, at least in part, on the speech reference point establishing events. While the speech reference point will generally be located on a display associated with apparatus 900, apparatus 900 is not so limited. In one embodiment, apparatus 900 may be aware of other devices. In this embodiment, the speech reference point may be established on another device. A co-verbal interaction may then be processed by apparatus 900 and its effects may be displayed or otherwise implemented on another device.

In one embodiment, the second logic 932 establishes the speech reference point based, at least in part, on a priority of the speech reference point establishing events handled by the first logic 931. Some events may have a higher priority or precedence than other events. For example, a slow or gentle gesture may have a lower priority than a fast or urgent gesture. Similarly, a set of rapid touches on a single item may have a higher priority than a single touch on the item. The second logic 932 may also establish the speech reference point based on an ordering of the speech reference point establishing events handled by the first logic 931. For example, a pinch gesture that follows a series of touch events may have a first meaning while a spread gesture followed by a series of touch events may have a second meaning based on the order of the gestures.

The second logic 932 may associate the speech reference point with different objects or regions. For example, the second logic 932 may associate the speech reference point with a single discrete object, with two or more discrete objects that are accessed simultaneously, with two or more discrete objects that are accessed sequentially, or with a region associated with one or more objects.

Apparatus 900 may include a third logic 933 that handles co-verbal interaction events. The co-verbal interaction events may include voice input events and other events including touch events, hover events, gesture events, or tactile events. The third logic 933 may simultaneously handle a voice event and a touch event, hover event, gesture event, or tactile event. For example, a user may say “delete this” while pointing to an object. Pointing to the object may establish the speech reference point and speaking the command may direct the apparatus 900 what to do with the object.

Apparatus 900 may include a fourth logic 934 that processes a co-verbal interaction between the user and the apparatus. The co-verbal interaction may include a voice command having a context. The context is determined, at least in part, by the speech reference point. For example, a speech reference point associated with an edge of a set of frames in a video preview widget may establish a “scrolling” context while a speech reference point associated with center frames in a video preview widget may establish a “preview” context that expands the frame for easier viewing. A spoken command (e.g., “back” or “view”) may then have more meaning to the video preview widget and provide a more accurate and natural user interaction with the widget.

In one embodiment, the fourth logic 934 processes the co-verbal interaction as a command to be applied to an object associated with the speech reference point. In another embodiment, the fourth logic 934 processes the co-verbal interaction as a dictation to be entered into an object associated with the speech reference point. In another embodiment, the fourth logic 934 processes the co-verbal interaction as a portion of a conversation with a voice agent.

Apparatus 900 may provide superior results when compared to conventional systems because multiple input modalities are combined. When a single input modality is employed, a binary result may allow two choices (e.g., activated, not activated). When multiple input modalities are combined, an analog result may allow a range of choices (e.g., faster, slower, bigger, smaller, expand, reduce, expand at a first rate, expand at a second rate). Conventionally, analog results may have been difficult, if even possible at all to achieve using pure voice commands and may have required multiple sequential inputs.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store remote media session data, user interface data, control data, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions.

In one embodiment, the apparatus 900 may be a general purpose computer that has been transformed into a special purpose computer through the inclusion of the set of logics 930. Apparatus 900 may interact with other apparatus, processes, and services through, for example, a computer network.

In one embodiment, the functionality associated with the set of logics 930 may be performed, at least in part, by hardware logic components including, but not limited to, field-programmable gate arrays (FPGAs), application specific integrated circuits (ASICs), application specific standard products (ASSPs), system on a chip systems (SOCs), or complex programmable logic devices (CPLDs).

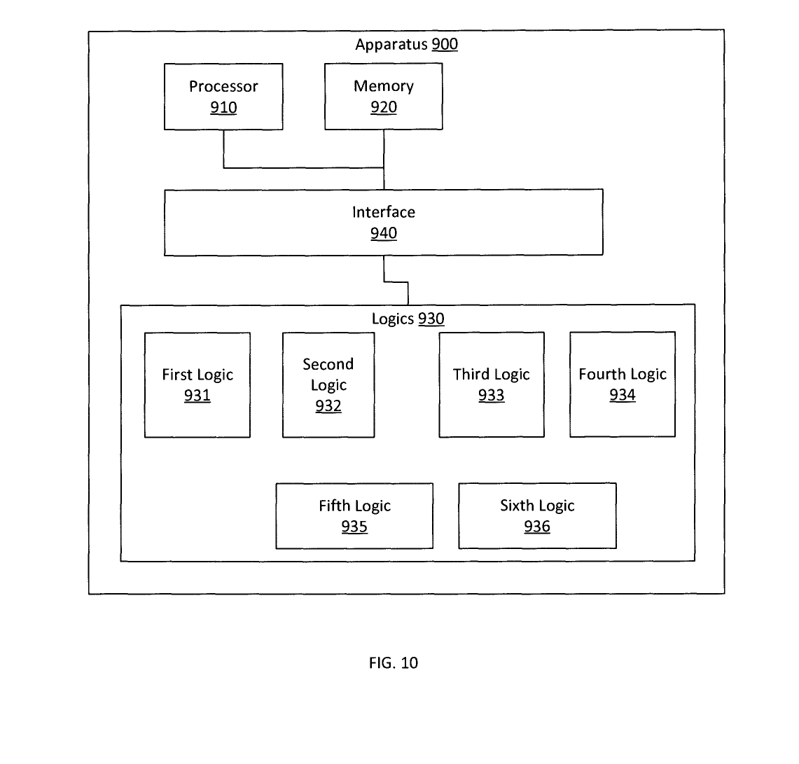

FIG. 10 illustrates another embodiment of apparatus 900. This embodiment of apparatus 900 includes a fifth logic 935 that provides feedback. The feedback provided by fifth logic 935 may include, for example, feedback associated with the establishment of the speech reference point. For example, when the speech reference point is established, the screen may flash, an icon may be enhanced, the apparatus 900 may make a pleasing sound, the apparatus 900 may vibrate in a known pattern, or other action may occur. This feedback may resemble a human interaction where a person pointing at an object to identify the object can read the feedback of another person to see whether that other person understands at which item the person is pointing. Fifth logic 935 may also provide feedback concerning the location of the speech reference point or concerning an object associated with the speech reference point. The feedback may be, for example, a visual output on apparatus 900. In one embodiment, fifth logic 935 may present an additional user interface element associated with the speech reference point. For example, a list of voice commands that may be applied to an icon may be presented or a set of directions in which an icon may be moved may be presented.

This embodiment of apparatus 900 also includes a sixth logic 936 that controls an active listening state associated with a voice agent on the apparatus. A voice agent may be, for example, an interface to a search engine or personal assistant. For example, a voice agent may field questions like “what time is it?” “remind me of this tomorrow,” or “where is the nearest flower shop?” Voice agents may employ an active listening mode that applies more resources to speech recognition and background noise suppression. The active listening mode may allow a user to speak a wider range of commands than when active listening is not active. When active listening is not active then apparatus 900 may only respond to, for example, an active listening trigger. When the apparatus 900 operates in active listening mode the apparatus 900 may consume more power. Therefore, sixth logic 936 may improve over conventional systems that have less sophisticated (e.g., single input modality) active listening triggers.

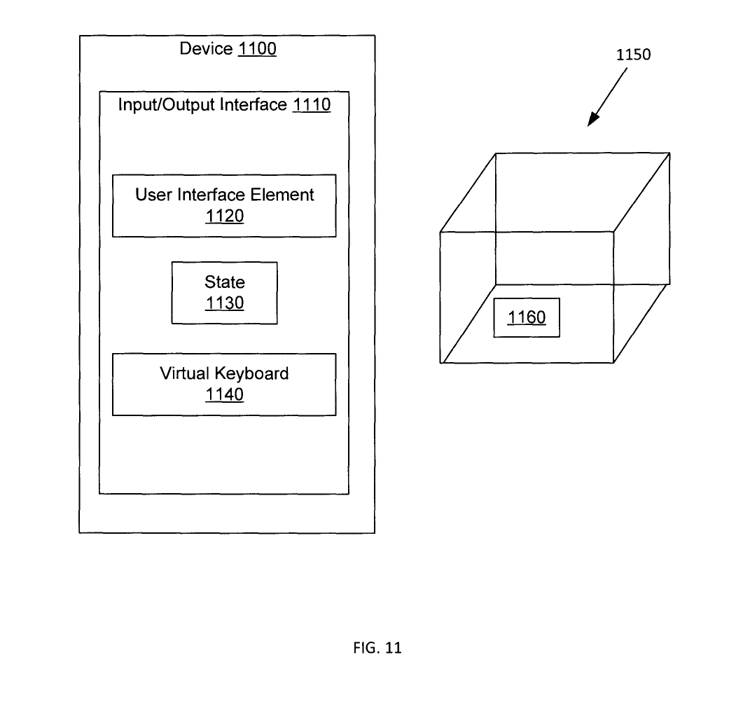

FIG. 11 illustrates an example hover-sensitive device 1100. Device 1100 includes an input/output (i/o) interface 1110. I/O interface 1100 is hover sensitive. I/O interface 1100 may display a set of items including, for example, a virtual keyboard 1140 and, more generically, a user interface element 1120. User interface elements may be used to display information and to receive user interactions. The user interactions may be performed in the hover-space 1150 without touching the device 1100. Device 1100 or i/o interface 1110 may store state 1130 about the user interface element 1120, the virtual keyboard 1140, or other items that are displayed. The state 1130 of the user interface element 1120 may depend on an action performed using virtual keyboard 1140. The state 1130 may include, for example, the location of an object designated as being associated with a primary hover point, the location of an object designated as being associated with a non-primary hover point, the location of a speech reference point, or other information. Which user interactions are performed may depend, at least in part, on which object in the hover-space is considered to be the primary hover-point or which user interface element 1120 is associated with the speech reference point. For example, an object associated with the primary hover point may make a gesture. At the same time, an object associated with a non-primary hover point may also appear to make a gesture.

The device 1100 may include a proximity detector that detects when an object (e.g., digit, pencil, stylus with capacitive tip) is close to but not touching the i/o interface 1110. The proximity detector may identify the location (x, y, z) of an object 1160 in the three-dimensional hover-space 1150. The proximity detector may also identify other attributes of the object 1160 including, for example, the speed with which the object 1160 is moving in the hover-space 1150, the orientation (e.g., pitch, roll, yaw) of the object 1160 with respect to the hover-space 1150, the direction in which the object 1160 is moving with respect to the hover-space 1150 or device 1100, a gesture being made by the object 1160, or other attributes of the object 1160. While a single object 1160 is illustrated, the proximity detector may detect more than one object in the hover-space 1150. The location and movements of object 1160 may be considered when establishing a speech reference point or when handling a co-verbal interaction.

In different examples, the proximity detector may use active or passive systems. For example, the proximity detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the proximity detector uses capacitive technology, the detector may include a set of capacitive sensing nodes to detect a capacitance change in the hover-space 1150. The capacitance change may be caused, for example, by a digit(s) (e.g., finger, thumb) or other object(s) (e.g., pen, capacitive stylus) that comes within the detection range of the capacitive sensing nodes. In another embodiment, when the proximity detector uses infrared light, the proximity detector may transmit infrared light and detect reflections of that light from an object within the detection range (e.g., in the hover-space 1150) of the infrared sensors. Similarly, when the proximity detector uses ultrasonic sound, the proximity detector may transmit a sound into the hover-space 1150 and then measure the echoes of the sounds. In another embodiment, when the proximity detector uses a photodetector, the proximity detector may track changes in light intensity. Increases in intensity may reveal the removal of an object from the hover-space 1150 while decreases in intensity may reveal the entry of an object into the hover-space 1150.

In general, a proximity detector includes a set of proximity sensors that generate a set of sensing fields in the hover-space 1150 associated with the i/o interface 1110. The proximity detector generates a signal when an object is detected in the hover-space 1150. In one embodiment, a single sensing field may be employed. In other embodiments, two or more sensing fields may be employed. In one embodiment, a single technology may be used to detect or characterize the object 1160 in the hover-space 1150. In another embodiment, a combination of two or more technologies may be used to detect or characterize the object 1160 in the hover-space 1150.

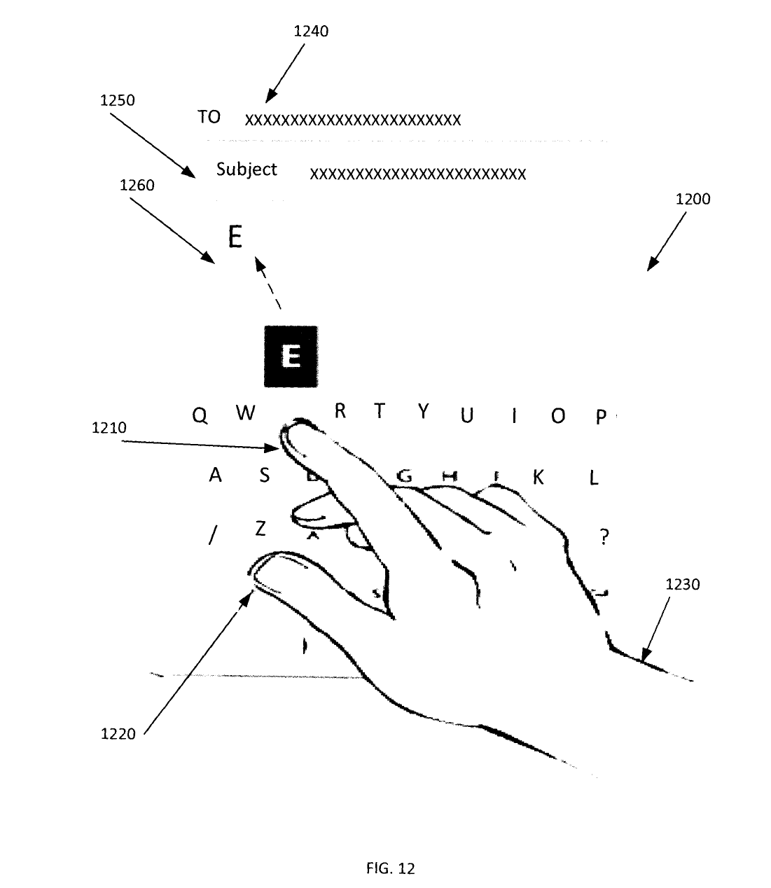

FIG. 12 illustrates a simulated touch and hover-sensitive device 1200. The index finger 1210 of a user has been designated as being associated with a primary hover point. Therefore, actions taken by the index finger 1210 cause i/o activity on the hover-sensitive device 1200. For example, hovering finger 1210 over a certain key on a virtual keyboard may cause that key to become highlighted. Then, making a simulated typing action (e.g., virtual key press) over the highlighted key may cause an input action that causes a certain keystroke to appear in a text input box. For example, the letter E may be placed in a text input box. Example apparatus and methods facilitate dictation or other actions without having to touch type on or near the screen. For example, a user may be able to establish a speech reference point in area 1260. Once the speech reference point is established, then the user may be able to dictate rather than type. Additionally, the user may be able to move the speech reference point from field to field (e.g., 1240 to 1250 to 1260) by gesturing. The user may establish a speech reference point that causes a previously hidden (e.g., shy) control like a keyboard to surface. The appearance of the keyboard may indicate that a user can now type or dictate. The user may change the entry point for the typing or dictation using, for example, a gesture. This multi-modal input approach improves over conventional systems by allowing a user to establish a context (e.g., text entry) and to navigate the text entry point at the same time.

### Aspects of Certain Embodiments

In one embodiment, an apparatus includes a processor, a memory, and a set of logics. The apparatus may include a physical interface to connect the processor, the memory, and the set of logics. The set of logics facilitate multi-modal interactions between a user and the apparatus. The set of logics may handle speech reference point establishing events and establish a speech reference point based, at least in part, on the speech reference point establishing events. The logics may also handle co-verbal interaction events and process a co-verbal interaction between the user and the apparatus. The co-verbal interaction may include a voice command having a context. The context may be determined, at least in part, by the speech reference point.

In another embodiment, a method includes establishing a speech reference point for a co-verbal interaction between a user and a device. The device may be a speech-enabled device that also has a visual display and at least one non-speech input apparatus (e.g., touch screen, hover screen, camera). The location of the speech reference point is determined, at least in part, by an input from the non-speech input apparatus. The method includes controlling the device to provide a feedback concerning the speech reference point. The method also includes receiving an input associated with a co-verbal interaction between the user and the device, and controlling the device to process the co-verbal interaction as a contextual voice command. A context associated with the voice command depends, at least in part, on the speech reference point.

In another embodiment, a system includes a display on which a user interface is displayed, a proximity detector, and a voice agent that accepts voice inputs from a user of the system. The system also includes an event handler that accepts non-voice inputs from the user. The non-voice inputs include an input from the proximity detector. The system also includes a co-verbal interaction handler that processes a voice input received within a threshold period of time of a non-voice input as a single multi-modal input.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
establishing a speech reference point for a co-verbal interaction between a user and a device, where the device is speech-enabled, where the device has a visual display, where the device has at least one non-speech input apparatus, and where a location of the speech reference point is determined, at least in part, by an input from the non-speech input apparatus;
controlling the device to provide a feedback concerning the speech reference point;
receiving an input associated with a co-verbal interaction between the user and the device, and
controlling the device to process the co-verbal interaction as a contextual voice command, where a context associated with the voice command depends, at least in part, on the speech reference point.

2. The method of claim 1, where the speech reference point is associated with a single discrete object displayed on the visual display.

3. The method of claim 1, where the speech reference point is associated with two or more discrete objects simultaneously displayed on the visual display.

4. The method of claim 1, where the speech reference point is associated with two or more discrete objects referenced sequentially on the visual display.

5. The method of claim 1, where the speech reference point is associated with a region associated with one or more representations of objects on the visual display.

6. The method of claim 1, where the device is a cellular telephone, a tablet computer, a phablet, a laptop computer, or a desktop computer.

7. The method of claim 1, where the co-verbal interaction is a command to be applied to an object associated with the speech reference point.

8. The method of claim 1, where the co-verbal interaction is a dictation to be entered into an object associated with the speech reference point.

9. The method of claim 1, where the co-verbal interaction is a portion of a conversation between the user and a speech agent on the device.

10. The method of claim 1, comprising controlling the device to provide visual, tactile, or auditory feedback that identifies an object associated with the speech reference point.

11. The method of claim 1, comprising controlling the device to present an additional user interface element based, at least in part, on an object associated with the speech reference point.

12. The method of claim 1, comprising selectively manipulating an active listening mode for a voice agent running on the device based, at least in part, on an object associated with the speech reference point.

13. The method of claim 12, comprising controlling the device to provide visual, tactile, or auditory feedback upon manipulating the active listening mode.

14. The method of claim 1, where the at least one non-speech input apparatus is a touch sensor, a hover sensor, a depth camera, an accelerometer, or a gyroscope.

15. The method of claim 14, where the input from the at least one non-speech input apparatus is a touch point, a hover point, a plurality of touch points, a plurality of hover points, a gesture location, a gesture direction, a plurality of gesture locations, a plurality of gesture directions, an area bounded by a gesture, a location identified using smart ink, an object identified using smart ink, a keyboard focus point, a mouse focus point, a touchpad focus point, an eye gaze location, or an eye gaze direction.

16. The method of claim 15, where establishing the speech reference point comprises computing an importance of a member of a plurality of inputs received from the at least one non-speech input apparatus, where members of the plurality have different priorities and where the importance is a function of a priority.

17. The method of claim 16, where the relative importance of a member depends, at least in part, on a time at which the member was received with respect to other members of the plurality.

18. An apparatus, comprising:
a processor;
a memory;
a set of logics that facilitate multi-modal interactions between a user and the apparatus, and
a physical interface to connect the processor, the memory, and the set of logics,
the set of logics comprising:
a first logic that handles speech reference point establishing events;
a second logic that establishes a speech reference point based, at least in part, on the speech reference point establishing events;
a third logic that handles co-verbal interaction events, and
a fourth logic that processes a co-verbal interaction between the user and the apparatus, where the co-verbal interaction includes a voice command having a context, where the context is determined, at least in part, by the speech reference point.

19. The apparatus of claim 18, where the first logic handles touch events, hover events, gesture events, or tactile events associated with a touch screen, a hover screen, a camera, an accelerometer, or a gyroscope.

20. The apparatus of claim 19, where the second logic establishes the speech reference point based, at least in part, on a priority of the speech reference point establishing events handled by the first logic or on an ordering of the speech reference point establishing events handled by the first logic,
and where the second logic associates the speech reference point with a single discrete object, with two or more discrete objects accessed simultaneously, with two or more discrete objects accessed sequentially, or with a region associated with one or more objects.

21. The apparatus of claim 20, where the co-verbal interaction events include voice input events, touch events, hover events, gesture events, or tactile events, and where the third logic simultaneously handles a voice event and a touch event, hover event, gesture event, or tactile event.

22. The apparatus of claim 21, where the fourth logic processes the co-verbal interaction as a command to be applied to an object associated with the speech reference point, as a dictation to be entered into an object associated with the speech reference point, or as a portion of a conversation with a voice agent.

23. The apparatus of claim 18, comprising a fifth logic that provides feedback associated with the establishment of the speech reference point, provides feedback concerning the location of the speech reference point, provides feedback concerning an object associated with the speech reference point, or presents an additional user interface element associated with the speech reference point.

24. The apparatus of claim 18, comprising a sixth logic that controls an active listening state associated with a voice agent on the apparatus.

25. A system, comprising:
a display on which a user interface is displayed;
a proximity detector;
a voice agent that accepts voice inputs from a user of the system;
an event handler that accepts non-voice inputs from the user, where the non-voice inputs include an input from the proximity detector, and
a co-verbal interaction handler that processes a voice input received within a threshold period of time of a non-voice input as a single multi-modal input.
